(19) United States
(12) Patent Application Publication
(10) Pub. No.: US 2015/0248782 A1
(43) Pub. Date: Sep. 3, 2015

(54) QUANTITATIVE SPECTRAL IMAGING

(71) Applicant: KONINKLIJKE PHILIPS N.V., Eindhoven (NL)

(72) Inventor: Roland Proksa, Neu Wulmstorf (DE)

(73) Assignee: KONINKLIJKE PHILIPS N.V., Eindhoven (NL)

(21) Appl. No.: 14/433,750

(22) PCT Filed: Oct. 2, 2013
(86) PCT No.: PCT/IB2013/059060

§ 371 Date: Apr. 6, 2015

Related U.S. Application Data
(60) Provisional application No. 61/711,428, filed on Oct. 9, 2012.
(60) Provisional application No. 61/711,559, filed on Oct. 9, 2012.

(51) Int. Cl. G06T 11/60; G06T 5/00

(52) U.S. Cl. CPC G06T 11/60; G06T 5/002; G06T 2207/10004; G06T 2207/10081

(57) ABSTRACT

A method includes generating a first measurement spectral image from first spectral image data based on a predetermined measurement energy. The method further includes determining a first measurement value for a first region of interest in the first measurement spectral image. The method further includes overlying the first measurement value in connection with a corresponding first region of interest in a visually presented first display spectral image, wherein the measurement energy is different from a first display energy of the first display spectral image.

The following generally relates to quantitative imaging and more particularly to reporting measurements for quantitative imaging, and is described with particular application to computed tomography (CT). However, the following is also amenable to other radiation attenuation based imaging modalities such as X-ray and/or other imaging modality.

A typical CT scanner has included an x-ray tube mounted on a rotatable gantry opposite a detector. The x-ray tube rotates around an examination region and emits polychromatic radiation that traverses the examination region and a subject and/or object disposed therein. The detector array detects radiation that traverses the examination region and produces a signal indicative thereof. A reconstructor reconstructs the signal and generates volumetric image data indicative of the subject and/or object disposed in the examination region. One or more images can be generated from the volumetric image data.

Existing image data analysis software applications include tools that determine information from a displayed image. For example, tools exist that allow the user to measure a distance between two points in a displayed image, measure a noise level for a predefined region of interest in a displayed image, measure an average attenuation value (e.g., a CT number in Hounsfield units based on the Hounsfield scale) for a predefined region of interest in a displayed image, etc. Unfortunately, for the latter, the measured attenuation values in a CT scan show variations (e.g., due to the polychromatic emission spectrum) and thus cannot be considered as quantitative information.

Spectral CT scanners can overcome this. Examples of spectral CT scanners include scanners with energy switching x-ray tubes, multiple x-ray tubes, scanners with multiple detector layers, and scanner with photon counting detectors. For scanners with multiple x-ray tubes, energy-dependent decomposition techniques can be used to generate quasi mono-chromatic images. Scanners with multiple detector layers and/or photon counting detectors have an inherent ability to produce quasi mono energetic images. Generally, these images represent the attenuation of a mono energetic beam at a specific energy and include information that represents a physical quantity.

Unfortunately, the quasi mono energetic images will contain unwanted noise. Generally, the noise will depend on the selected x-ray tube energy, the spectral properties of the scanner, and the imaging protocol. Furthermore, a clear noise minimum can be obtained at a particular energy level as the optimum (or minimum noise) level may vary and therefore might not correspond to mono energy level for measurement reporting. In view of the above, there is an unresolved need for another approach for quantitative imaging.

Aspects described herein address the above-referenced problems and others.

In one aspect, a method includes generating a first measurement spectral image from first spectral image data based on a predetermined energy. The method further includes determining a first measurement value for a first region of interest in the first measurement spectral image. The method further includes overlying the first measurement value in connection with a corresponding first region of interest in a visually presented first display spectral image, wherein the energy is different from a first display energy of the first display spectral image.

In another aspect, a system includes a reconstructor that generates a measurement spectral image from spectral image data based on a measurement energy. The system further includes a measurement energy identifier that determines a first measurement value for a first region of interest in the measurement spectral image. The system further includes a rendering engine that overlays the first measurement value in connection with a corresponding first region of interest in a visually presented first display spectral image, wherein the measurement energy is different from a first energy of the first display spectral image.

In another aspect, a computer readable storage medium is encoded with computer readable instructions. The computer readable instructions, when executed by a processer, causes the processor to: generate a first measurement spectral image from first spectral image data based on a predetermined measurement energy, determine a first measurement value for a first region of interest in the first measurement spectral image, and overlay the first measurement value in connection with a corresponding first region of interest in a visually presented first display spectral image, wherein the measurement energy is different from a first display energy of the first display spectral image.

The invention may take form in various components and arrangements of components, and in various steps and arrangements of steps. The drawings are only for purposes of illustrating the preferred embodiments and are not to be construed as limiting the invention.

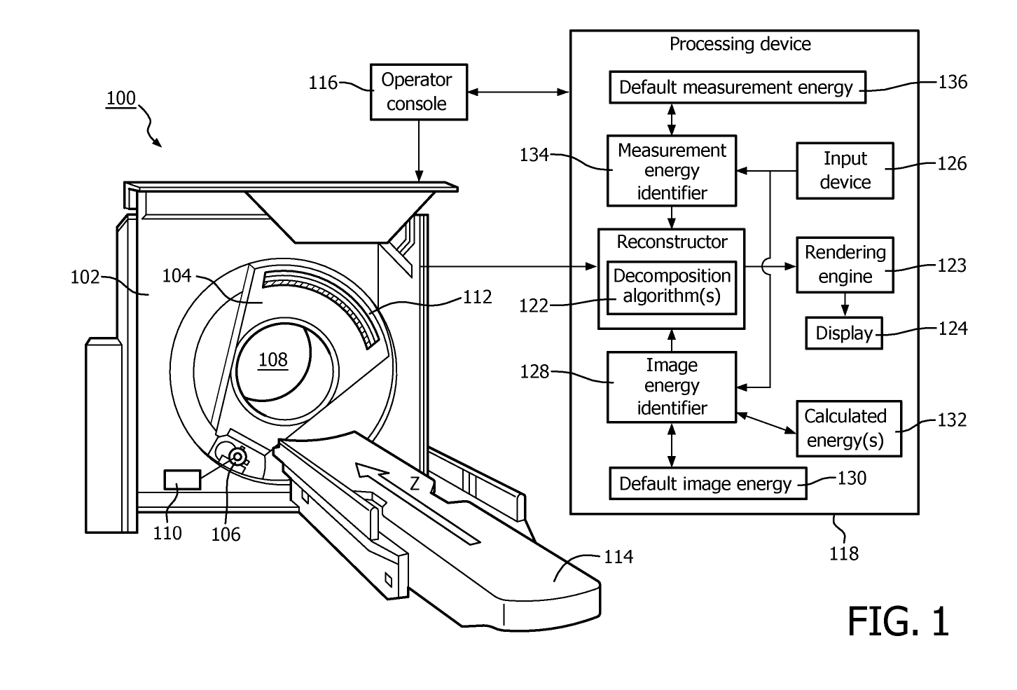

FIG. 1 schematically illustrates an example imaging system in connection with a processing device.

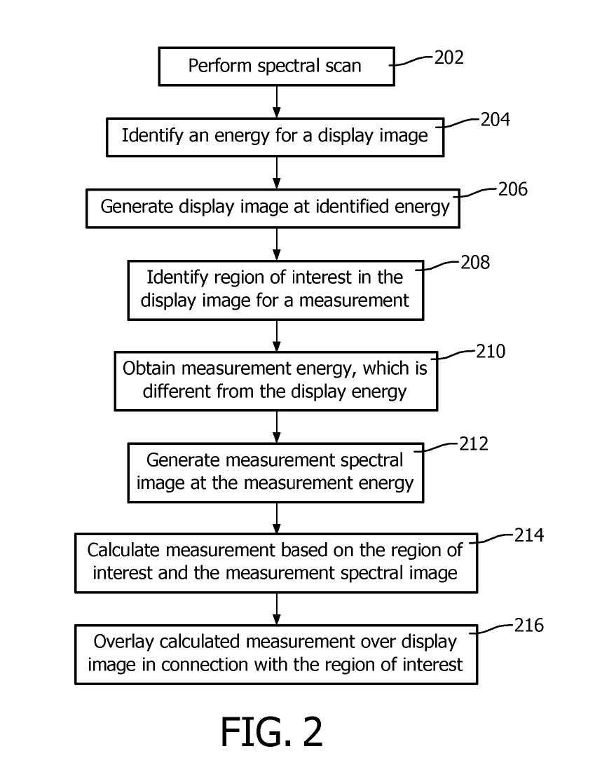

FIG. 2 illustrates an example method for displaying measurements in connection with an image.

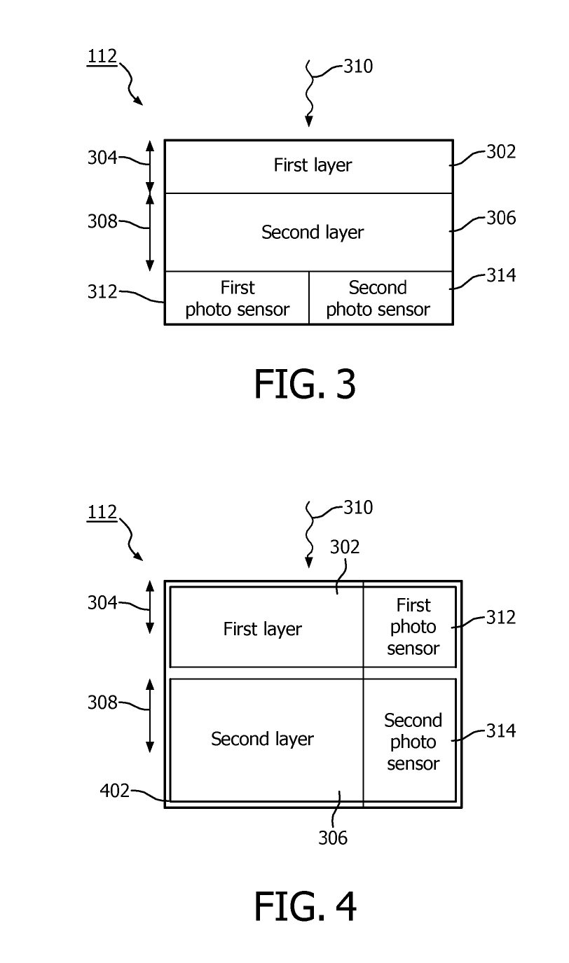

FIG. 3 schematically illustrates an example dual layer detector.

FIG. 4 schematically illustrates another example dual layer detector.

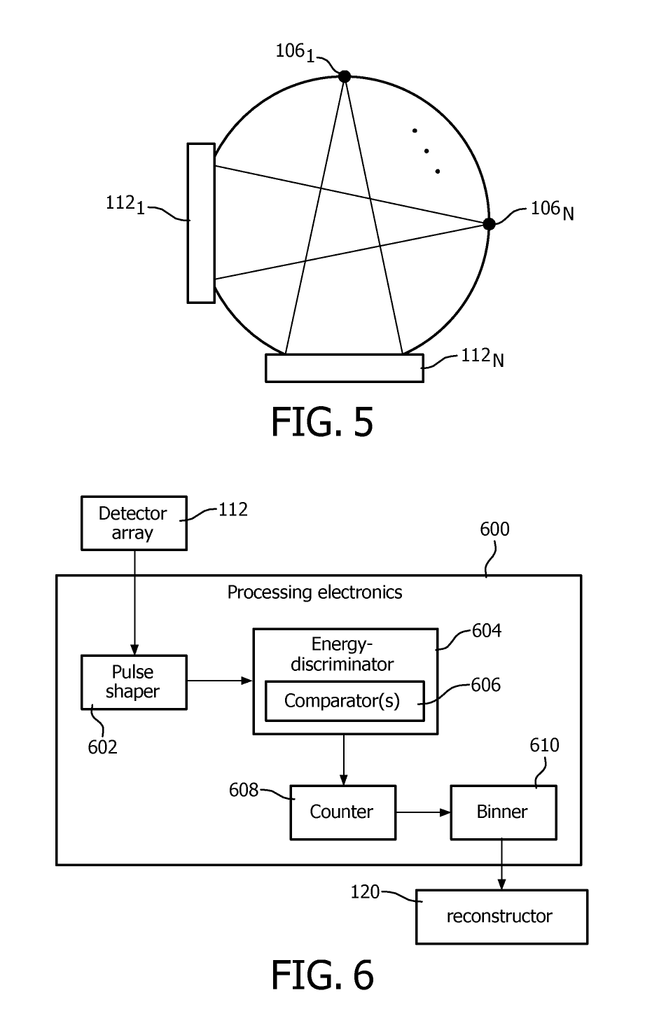

FIG. 5 schematically illustrates a multi-radiation source imaging system.

FIG. 6 schematically illustrates a detector array with a photon-counting detector and corresponding processing electronics.

The following describes an approach in which a measurement for a region of interest identified in a displayed spectral image is calculated based on the same region of interest in a different but corresponding spectral image. By way of example, where a same image data set can be used to generate multiple spectral images, each for a different energy, a first spectral image for a first energy can be displayed whereas a CT number measurement overlaid over the first spectral image for a region of interest identified in the first spectral image is determined based on a second spectral image for a second different energy.

In one instance, this allows a user to scroll through the different energy images and select a spectral image to display for observation or chose a default spectral image such as the spectral image with a lowest noise level or highest contrast level to display for observation while measurement calculations are made using a same spectral image, rendering the measurement independent of the energy of the displayed spectral image and/or providing an energy normalized measurement that can be compared with other measurements calculated from a same energy image.

With reference to FIG. 1, an imaging system 100 includes a computed tomography (CT) scanner, which includes a generally stationary gantry portion 102 and a rotating gantry portion 104. The rotating gantry portion 104 is rotatably supported by the generally stationary gantry portion 102 via a bearing (not visible) or the like.

A radiation source 106, such as an x-ray tube, is supported by the rotating gantry portion 104 and rotates therewith around an examination region 108 about a longitudinal or z-axis. A radiation source voltage controller 110 controls a target (mean or peak) emission voltage of the radiation source 106. In one instance, this includes switching the emission voltage between two or more emission voltages (e.g., 80 keV and 140 keV, 80 kV, 100 keV and 120 keV, etc.) between views of a scan, within a view of a scan, and/or otherwise. As a result, radiation beams with different energy spectra may be used to scan a subject/object in a same scan.

A detector array 112 subtends an angular arc opposite the examination region 108 relative to the radiation source 106. The detector array 112 detects radiation that traverses the examination region 108 and generates a signal indicative thereof. Where the scan is a multiple energy beam scan and the radiation source voltage is switched between at least two emission voltages for a scan, the detector array 112 generates a signal, dₙ (where n is an integer value corresponding to a particular energy), for each of the radiation source voltages. As discussed below, energy-resolving detectors that generate energy dependent signals can be included in the detector array 112.

A couch or subject support 114 supports a subject or object in the examination region 108. The support 114 positions the subject or object in the examination region 108 before, during and/or after scanning An operator console 116 facilitates user interaction with the scanner 100. For example, software applications executed by the operator console 116 allows a user to select an imaging protocol such as an imaging protocol that includes switching the radiation source emission voltage for a scan, select a spectral reconstruction algorithm, initiate scanning, etc.

A processing device 118 processes the signals dₙ. It is to be appreciated that the processing device 118 includes one or more micro-processors that execute one or more computer readable instructions to implement the below discussed functionality performed thereby. In one instance, the one or more computer readable instructions are encoded on computer readable storage medium such a physical memory and/or other non-transitory medium. Additionally or alternatively, a computer readable instruction can be carried by a carrier waver, a signal and/or other transitory medium.

The illustrated processing device 118 includes a reconstructor 120 that reconstructs the signals dₙ and generates volumetric image data. For a multiple energy scan, the reconstructor 120 can employs one or more spectral decomposition algorithms 122 and/or other spectral reconstruction algorithms. By way of non-limiting example, in one instance, the reconstructor 120 employs a decomposition algorithm that models the signals as a combination of the photo-electric effect with attenuation spectrum P(E) and the Compton effect with attenuation spectrum C(E).

The density length product for these components, namely, that of the photo-electric effect component p and the Compton effect component c, in each signal dₙ can be modeled as a non-linear system according to the relationship:

dₙ=∫dE T(E) Dₙ(E)exp(−(p P(E)+c C(E))), Equation 1

where T(E) is the emission spectrum of the radiation source 106 and D (E) is the spectral sensitivity of the nth measurement. Where at least two detection signals are available for at least two energy ranges (e.g., a dual energy scan), a system of at least two equations can be formed having two unknowns, which can be solved with known numerical methods for p and c.

The results, p and c, can be used alone or in combination to reconstruct images of a desired energy component using known and/or other reconstruction algorithms. Sensitivity and noise robustness may generally be improved by, for example, increasing the number of energy ranges. In another instance, the reconstructor 120 reconstructs the signals dₙ into individual images, using image based analysis algorithms. One non-limiting approach is to perform an N-dimensional cluster analysis to decompose the images into components such as soft tissue, calcium, iodine or other materials, where N is the number of distinct spectral measurements performed for each geometric ray.

A display 124 visually presents one or more spectral images for one or more different energy levels. In one instance, the display 124 visually presents the one or more spectral images in connection with an interactive graphical user interface (GUI), which includes software based tools that can be activated through icons and/or other graphical indicia presented in the GUI with an input signal from an input device 126 such as a keyboard, a mouse, a touch screen, etc. Such tools may include visualization tools (e.g., window/level, zoom, pan, rotate, etc.), measurements tools (e.g., CT number, length, noise, etc.), and/or other tools.

An image energy identifier 128 identifies the energy level for displayed image. In the illustrated embodiment, the image energy identifier 128 can employ a default image energy 130, one or more calculated energy 132, or an energy specified in an input signal from the input device 126. By way of non-limiting example, the image energy identifier 128 may first use the default image energy 130. The default image energy 130 may be determined by the manufacturer of the display software application, a clinical imaging site, a group of clinical experts, a standardization body, and/or otherwise.

The input device 126 can then be used to select a particular calculated energy 132. In one instance, the one or more calculated energies 132 are each visually presented via the display 124 as activateable software icons (e.g., buttons, menus items, or the like). In this instance, the user uses the input device 126 to activate a desired one of the one or more calculated energies 132, for example, via mouse. An example calculated energy corresponds to the energy resulting in an image with a least amount of noise or an image with a highest contrast material level.

The energy specified in the input signal from the input device 126 can be a particular value such as an energy value entered at the keypad of a keyboard input device 126, selected by a mouse input device 126 through a menu of predefined values, etc. In another instance, the software icon can present a graphical slider which maps each slider position to a different energy. In this instance, the user can slide the slider using the input device 126 to dynamically change the energy identified for presenting the image.

A measurement energy identifier 134 identifies an energy value for the image which is used to take measurements such as determine an average CT number of a region of interest of the displayed image. In the illustrated embodiment, the measurement energy identifier 134 can employ a default measurement energy 136 (or, optionally, an energy specified in an input signal from the input device 126). By way of non-limiting example, the measurement energy identifier 134 may in general use a default measurement energy 136 that corresponds to a regional, national and/or international standardized energy and/or other energy.

In one instance, the energy valued identified by the image energy identifier 128 and the energy identified by the measurement energy identifier 134 are different values. For instance, the energy corresponding to a particular noise level or contrast material level may vary between scans, scanned objects and/or subjects, etc. Thus, the image energy value determined by the image energy identifier 128 may vary from study to study. However, the default measurement energy 136 may remain the same. This allows the user to select a spectral image at any energy for display while calculating measurements at the same energy, which provides an energy normalized measurement.

When displaying a spectral image, the particular energy value can also be displayed and/or made otherwise available. Likewise, when displaying a measurement value, the particular energy value can be displayed and/or made otherwise available. For instance, when determining an average CT number for a region of interest, the displayed measurement value may be presented as: “100 HU at 65 keV”, even though the displayed image is not a 65 keV image. Using a standardized measurement energy value for calculating measurements is well suited for applications in which images and measurements are compared, e.g., pre and post tumor treatment images, because a change in a measurement between two images will not be a function of a change in the energy.

FIG. 2 illustrates an example method for visually presenting an image and calculating and overlaying a measurement for a region of interests identified in the visually presented image.

It is to be appreciated that the ordering of the acts in these methods is not limiting. As such, other orderings are contemplated herein. In addition, one or more acts may be omitted and/or one or more additional acts may be included.

At 202, a spectral scan is performed, producing an image data set that can be used to generate one or more images for one or more different energy levels.

At 204, an energy is identified for a display image.

At 206, a spectral image at the identified energy is generated, producing the display image, and displayed.

At 208, a region of interest is identified in the displayed display spectral image for a measurement.

At 210, a measurement energy, which is different from the display image energy, is obtained.

At 212, a spectral image at the measurement energy is generated, producing a measurement image corresponding to the display image.

At 214, the measurement is calculated based on the region of interest and the measurement image.

At 216, the measurement is overlaid over the display image in connection with the identified region of interest. As discussed herein, the measurement energy is optionally displayed along with the overlaid measurement.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

Variations are discussed next.

FIGS. 3 and 4 schematically illustrate variations in which the detector array 112 includes multi-layer energy-resolving detectors. This detector array 112 may be used in configurations which of the system 100 with and without the radiation source voltage controller 110.

In FIG. 3, the detector array 112 includes a dual layer detector with a first layer 302 of a first scintillation material having a first thickness 304 and a second layer 306 of a second scintillation material having a second thickness 308. The first and second scintillator layers 302 and 306 are stacked in a configuration in which the first layer 302 is closer to impinging radiation 310. First and second photo-sensors 312 and 314 are arranged next to each other along a direction transverse to the stacking of the scintillator 302 and 306 and under the stacked scintillators 302 and 306, relative to the direction of the incoming radiation.

Energy absorption is dependent on the thickness of the material(s) used to form the first and second scintillation layers 302 and 306. In this example, the thickness 304 of the first layer 302 is thinner relative to the thickness 308 of the second layer 306. In other embodiments, the thicknesses 304 and 308 may be equal or the thickness 304 may be thinner than the thickness 308. The spectral separation, generally, is given by the fact that the first layer absorbs the low energy photons, which have higher absorption likelihood than high energy photons.

The photo-sensors 312 and 314 have emission spectra that match to the spectral sensitivities of the corresponding scintillation layers 302 and 306. As a result, only the light emitted by the first scintillation layer 302 is absorbed by the first photo-sensor 312, and only the light emitted by the second scintillation layer 306 is absorbed by the second photo-sensor 314. The photo-sensors 312 and 314 respectively detect the light produced by the first and second layers 302 and 306 and generate and output different signals corresponding to the spectral sensitivities of the corresponding scintillation layers 302 and 306.

FIG. 4 shows a variation of FIG. 3 in which the photo-sensors 312 and 314 are stacked in a direction of the impinging radiation 310 and arranged parallel to the stacked scintillators 302 and 306 in a direction perpendicular to the impinging radiation 310. In this embodiment, a light reflective coating 402 may be included on surfaces of the first and second layers 302 and 306 to respectively direct light to the photo-sensors 312 and 314. Other detector arrangements are also contemplated herein. Likewise, the first and second layers 302 and 306 generate and output different signals corresponding to the spectral sensitivities of the corresponding scintillation layers 302 and 306.

FIG. 5 schematically illustrates a variation of the system 100 that includes multiple radiation sources 106₁, . . . , 106_{N} (where N is an integer) and corresponding detector arrays 112₁, . . . , 112_{N}. Each source/detector pair generates and outputs a signal having different spectral characteristics. This multi-radiation source configuration may be used in configurations with the detector arrays 112 of FIGS. 1, 3 and/or 4 and/or in configurations in which of the system 100 includes or does not include the radiation source voltage controller 110.

FIG. 6 schematically illustrates a variation in which the detector array 112 includes photon counting detectors. In this instance, the detector array 112 generates a signal, such as an electrical current or voltage signals, having a peak amplitude that is indicative of the energy of a detected photon, and processing electronics 600 identify and/or associates the detected photon with an energy range corresponding to the energy of the detected photon for the detected photon based on the signal.

As shown, in this example, the processing electronics 600 includes a pulse shaper 602 that processes the signal and generates a pulse such as voltage or other pulse indicative of the energy of the detected photon. An energy-discriminator 604 energy discriminates the pulse. In the illustrated example, the energy-discriminator 604 includes multiple comparators 606. Each comparator 606 receives the pulse and compares a peak amplitude of the pulse to an energy level threshold. A comparator 606 produces an output indicative of whether the amplitude exceeds the corresponding threshold.

A counter 608 increments a count value for each threshold based on the output of the energy-discriminator 604. A binner 610 energy bins the signals and, hence, the photons into two or more energy ranges or windows based on the counts. For example, a bin may be defined for the energy range between two thresholds. In this instance, the reconstructor 120 selectively reconstructs the signals generated by the detector 112 based on the spectral characteristics of the signals.

Other variations in which spectral image data can be obtained are also contemplated herein.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
generating a first measurement spectral image from first spectral image data based on a predetermined measurement energy;
determining a first measurement value for a first region of interest in the first measurement spectral image; and
overlying the first measurement value in connection with a corresponding first region of interest in a visually presented first display spectral image, wherein the measurement energy is different from a first display energy of the first display spectral image.

2. The method of claim 1, wherein the first display energy corresponds to a lower image noise spectral image of the first spectral image data.

3. The method of claim 1, wherein the first display energy corresponds to a higher image contrast material level spectral image of the first spectral image data.

4. The method of claim 1, further comprising;
receiving an input indicative of a user selected energy for the first display energy.

5. The method of claim 1, further comprising:
changing the first display spectral image to another display spectral image corresponding to another display energy, which is different from the first display energy and the measurement energy.

6. The method of claim 1, further comprising:
overlaying indicia identifying the measurement energy in connection with the first region of interest over the first display spectral image.

7. The method of claim 1, further comprising:
visually presenting indicia identifying the first display energy over the first display image.

8. The method of claim 1, further comprising:
visually displaying a second display spectral image corresponding to a second display energy, which is different from the first display energy and the measurement energy, wherein the second spectral display image is displayed concurrently with the first spectral display image.

9. The method of claim 8, further comprising:
determining a second measurement value for a second region of interest in the first measurement spectral image; and
overlying the second measurement value in connection with a corresponding second region of interest in the second display spectral image.

10. The method of claim 1, further comprising:
generating a third spectral display image from second spectral image data;
generating a second measurement spectral image from the second spectral image data based on the predetermined measurement energy;
determining a third measurement value for the first region of interest in the second measurement spectral image; and
overlying the third measurement value in connection with a corresponding first region of interest in the third display spectral image.

11. The method of claim 10, further comprising:
concurrently displaying the first and third display spectral display images, wherein the first and second spectral image data are from different scans.

12. A system, comprising:
a reconstructor that generates a measurement spectral image from spectral image data based on a measurement energy;
a measurement energy identifier that determines a first measurement value for a first region of interest in the measurement spectral image; and
a rendering engine that overlays the first measurement value in connection with a corresponding first region of interest in a visually presented first display spectral image, wherein the measurement energy is different from a first energy of the first display spectral image.

13. The system of claim 12, wherein the first energy of the first display spectral image corresponds to a lower image noise spectral image.

14. The system of claim 12, wherein the first energy of the first display spectral image corresponds to a higher image contrast material spectral image.

15. The system of claim 12, wherein the first energy corresponds to an input signal indicative of a user selected energy.

16. The system of claim 12, wherein the rendering engine changes the first display spectral image to another display spectral image corresponding to another energy, which is different from the first energy and the measurement energy.

17. The system of claim 12, wherein the rendering engine overlays indicia identifying the measurement energy in connection with the first region of interest.

18. The system of claim 12, wherein the rendering engine visually presents indicia identifying the first energy of the first display image over the first display image.

19. The system of claim 12, wherein the rendering engine visually displays a second display spectral image corresponding to a second energy, which is different from the first energy of the first display image and the measurement energy, wherein the second spectral image is displayed concurrently with the first spectral image data,

20. A computer readable storage medium encoded with computer readable instructions, which, when executed by a processer, causes the processor to:
generate a first measurement spectral image from first spectral image data based on a predetermined measurement energy;
determine a first measurement value for a first region of interest in the first measurement spectral image; and
overly the first measurement value in connection with a corresponding first region of interest in a visually presented first display spectral image, wherein the measurement energy is different from a first display energy of the first display spectral image.
